(19) United States
(12) Patent Application Publication
(10) Pub. No.: US 2003/0179316 A1
(43) Pub. Date: Sep. 25, 2003

(54) Method for reproducing digital information signal and digital information signal decorder

(75) Inventor: Koji Morooka, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/390,758

(22) Filed: Mar. 19, 2003

(30) Foreign Application Priority Data
Mar. 19, 2002 (JP) 2002-076072

(51) Int. Cl. H04N 11/00

(52) U.S. Cl. 348/468; 348/465

(57) ABSTRACT

An A/D converter samples TV signals during a blanking interval at a frequency fs which is higher than a transmission frequency ft of a teletext signal. A CPU finds a difference between the sampled digital data and a slice value to calculate a first address in which a sign of the difference reverses. Then, it compares the first address with a second address which represents timing and determines sampling timing of the teletext signal in accordance with the compared result.

### BACKGROUND OF THE INVENTION

The present invention relates to a technique for reproducing a digital information signal such as a teletext or a closed caption which is superposed and transmitted during a blanking interval of TV signals.

A teletext and a closed caption are services in which literal or graphic information is superposed on a video signal as a digitalized signal and transmitted during a vertical blanking interval of television signals, and the data are sampled by a decoding circuit in a receiver at a receiving side and reproduced so that the transmitted literal or graphic information are shown on a screen.

Since the teletext is superposed on a video signal at a transmission clock frequency Ft (6.9375 MHz) and transmitted, it is necessary to sample data at a clock frequency Fs which is synchronized with the transmission clock frequency Ft in a receiver. Therefore, a Clock Run-In (CRI) signal for 16 clocks is added to the teletext signal for clock-synchronization at a head of the data. An optimum sampling clock phase is determined from this CRI signal and the data of 45 bytes (including the CRI signal) for one horizontal interval are sampled at the determined clock phase. As for the closed caption, since only a transmission frequency and an amount of information superposed for one horizontal interval are different, a method for sampling data is the same as in the teletext.

However, if there is an influence of phase distortion on a transmission line, even if the clock phase for sampling is determined from the CRI signal, it is shifted from a clock phase for ideal sampling. Thus, as a method for performing data reproduction normally even when the phase distortion is generated, a transversal filter circuit has been employed.

FIG. 12 is a view showing a structure of a conventional teletext decoder. TV signals containing a teletext signal which is influenced by the phase distortion are converted to digital signals by an A/D converter 11 and read out to a RAM 62 through a RAM 52 and a RAM 53. A CPU 61 performs arithmetical operations in accordance with algorithm such as minimum square error (MSE) method or zero-forcing (ZF) method stored in a ROM 63 to find the distortion generated on the transmission line and finds and the CPU sets a tap coefficient of a transversal filter 51 which is necessary to remove the phase distortion generated on the transmission line. A CRI sampling circuit 58 samples the CRI signal from the signal from which the phase distortion is removed by the transversal filer 51, a clock selective circuit 59 determines a phase of a sampling clock such that an eye open area ratio of the CRI signal becomes maximum, a slicing circuit 56 digitalizes the teletext signal according to this clock phase and a decoding circuit 57 decodes the digitalized data.

Conventionally, as a method for correcting the phase distortion of a digital signal, a transversal-type digital filter has been employed in general. However, correction performance in this case depends on the number of taps of the digital filter and the number of arithmetic bits. In general, several tens (about 32 to 64) of taps are necessary for appropriate correction. Meanwhile, since the tap of the digital filter is formed of a multiplier, in case the decoding process is implemented on the hardware, several tens of multipliers are necessary, which extremely increases a circuit area.

In addition, in case the digital filtering operation is implemented with software, in addition to calculations of algorithm such as minimum square error (MSE) or zero-forcing (ZF) for calculation of the tap coefficient, it is necessary to perform an operation of sum of products implemented by the digital filter and, in a structure in which a decoder is mounted in a channel select microcomputer, it is also necessary to perform a channel selective operation. This series of operations can not be performed within 20 ms which is one vertical blanking interval of PAL, for example at an operating speed of a microcomputer used in consumer appliances.

### SUMMARY OF THE INVENTION

It is an object of the present invention to reproduce a digital information signal superposed and transmitted during a blanking interval of TV signals by a simple method without employing a digital filter operation, while an influence of phase distortion of the signal on a transmission line is appropriately controlled.

More specifically, according to the present invention, a method for reproducing a digital information signal superposed and transmitted during a blanking interval of TV signals comprises a first step of sampling and A/D converting the TV signals during the blanking interval at a frequency higher than a transmission frequency of the digital information signal; a second step of evaluating a difference between a slice value and a part corresponding to synchronization data of the digital information signal among the digital data obtained at the first step; and a third step of comparing reversing timing when a sign of the difference obtained at the second step reverses, with predetermined timing and determining data extracting timing for reproducing the digital information signal from the digital data according to the compared result.

According to the present invention, a difference between a part corresponding to synchronization data of the digital information signal to be reproduced among digital data obtained by the A/D converter and a slice value is found. Then, reversing timing when a sign of the difference reverses is compared with predetermined timing and data extracting timing for reproducing the digital information signal is determined in accordance with the compared result. More specifically, when the timing of intersection of the digital data of the part corresponding to the synchronization data with the slice value is shifted because of the phase distortion on the transmission line, for example, the shift of the timing is detected as a shift of reversing timing. Thus, if the data extracting timing is determined according to the compared result with the predetermined timing, the phase distortion on the transmission line can be appropriately prevented.

In addition, it is preferable that the sampling frequency at the first step of the present invention is a frequency corresponding to an integral multiple of the transmission frequency of the digital information signal.

Furthermore, it is preferable that the predetermined timing at the third step of the present invention is timing corresponding to timing when a sign of a difference reverses, on the assumption that no distortion occurs in a transmission system and ideal sampling is performed at the first step.

Moreover, it is preferable that in the third step, when the compared result shows that the reversing timing is earlier than the predetermined timing, the data extracting timing is hastened, while the data extracting timing is delayed when the compared result shows that the reversing timing is later than the predetermined timing.

Furthermore, it is preferable that the method of the present invention further comprises a fourth step of sampling data from the digital data according to the data extracting timing determined at the third step and digitalizing the sampled data based on the slice value, and the digitalized data are decoded into the digital information signal.

Furthermore, it is preferable that the method of the present invention further comprises a fifth step of performing a parity check about the digitalized data, and when a parity error is detected at the fifth step, the data extracting timing determined at the third step is corrected. Furthermore, it is preferable that the fourth step is performed using a plurality of slice values different from each other, a parity check is performed with respect to respective obtained digitalized data and the digitalized data with which the parity error is minimum is selected decoding. In addition, it is preferable that interruption process is performed in accordance with a channel switching operation and a power ON operation of an apparatus for reproducing the TV signals, and in the interruption process, the fourth step is performed using a plurality of slice values which are different from each other, a parity check is performed with respect to respective obtained digitalized data and a slice value with which the parity error is minimum is selected for the following digitalizing process.

Furthermore, according to the present invention, a decoder for reproducing a digital information signal superposed and transmitted during a blanking interval of TV signals comprises an A/D converter for sampling and A/D converting the TV signals during a blanking interval at a frequency higher than the transmission frequency of the digital information signal TV signals; difference means for evaluating a difference between a slice value and a part corresponding to synchronization data of the digital information signal among digital data generated by the A/D converter; and timing setting means for comparing reversing timing when a sign of the difference obtained by the difference means reverses, with predetermined timing and determining data extracting timing for reproducing the digital information signal from the digital data in accordance with the compared result.

According to the present invention, a difference between a part corresponding to synchronization data of the digital information signal to be reproduced among digital data obtained by the A/D converter, and a slice value is found. Then, reversing timing when a sign of the difference reverses is compared with predetermined timing and data extracting timing for reproducing the digital information signal is determined in accordance with the compared result. More specifically, when the timing of intersection of the digital data of the part corresponding to the synchronization data with the slice value is shifted because of the phase distortion on the transmission line, for example, the shift of the timing is detected as a shift of reversing timing. Thus, if the data extracting timing is determined according to the compared result with the predetermined timing, the phase distortion on the transmission line can be appropriately prevented.

Furthermore, the decoder according to the present invention further comprises a decoding part which extracts data from the digital data in accordance with the data extracting timing determined by the timing setting means, digitalizes the extracted data based on a slice value and reproduces it as the digital information signal.

### BRIEF DESCRIPTION OF THE DRAWINGS

FIG. 1 is a view showing a structure of a digital information signal decoder according to a first embodiment of the present invention.

FIG. 2 is a conceptual diagram showing a relation between a CRI signal and sampling under an ideal condition.

FIG. 3 is a conceptual diagram showing a condition that a phase of a sampling clock is advanced as compared with that in FIG. 2.

FIG. 4 is a conceptual diagram showing a condition that a phase of a sampling clock is delayed as compared with that in FIG. 2.

FIG. 5 is a block diagram conceptually showing a function of an optimal control for data extracting timing according to the first embodiment of the present invention.

FIG. 6 is a flowchart showing processes according to the first embodiment of the present invention.

FIG. 7 is a flowchart showing processes according to a second embodiment of the present invention.

FIG. 8 is a flowchart showing processes according to the second embodiment of the present invention.

FIG. 9 is a flowchart showing processes for digitalization and a parity check according to a variation of the first embodiment of the present invention.

FIG. 10 is a flowchart showing processes according to a third embodiment of the present invention.

FIG. 11 is a flowchart showing concrete processes for correction of a slice value shown in FIG. 10.

FIG. 12 is a view showing a structure of a conventional teletext signal decoder.

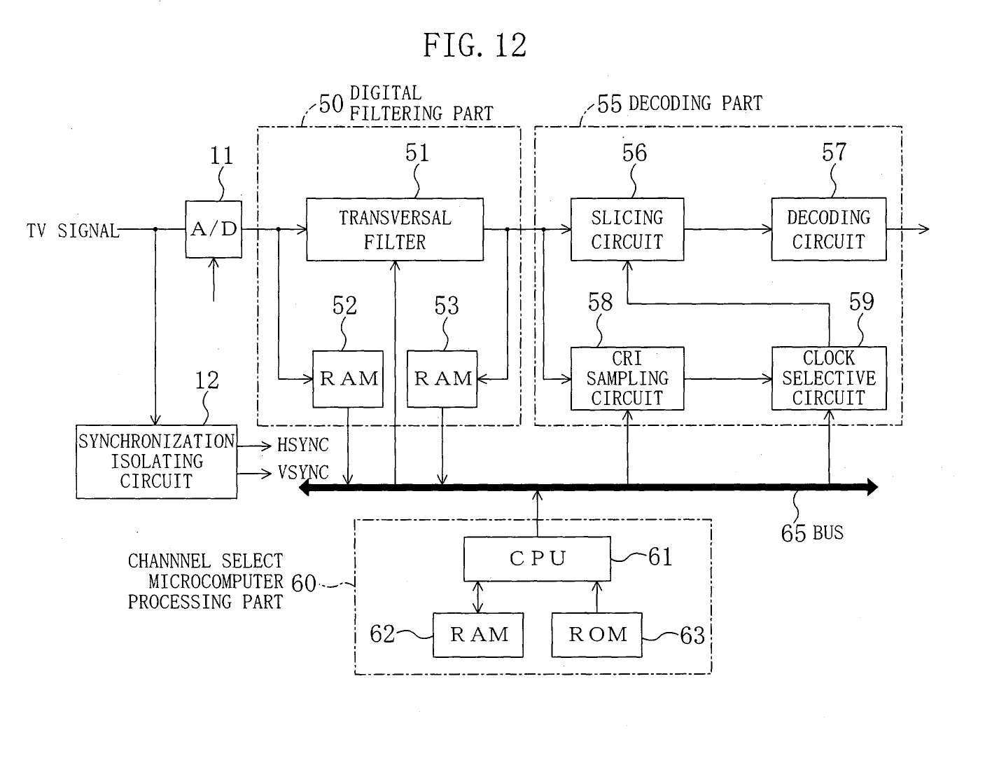

### DETAILED DESCRIPTION OF THE INVENTION

Hereinafter, embodiments of the present invention will be described with reference to the accompanying drawings.

In addition, a method for superposing and transmitting a digital information signal during a blanking interval of TV signals will be described in reference to a case of a teletext.

Embodiment 1

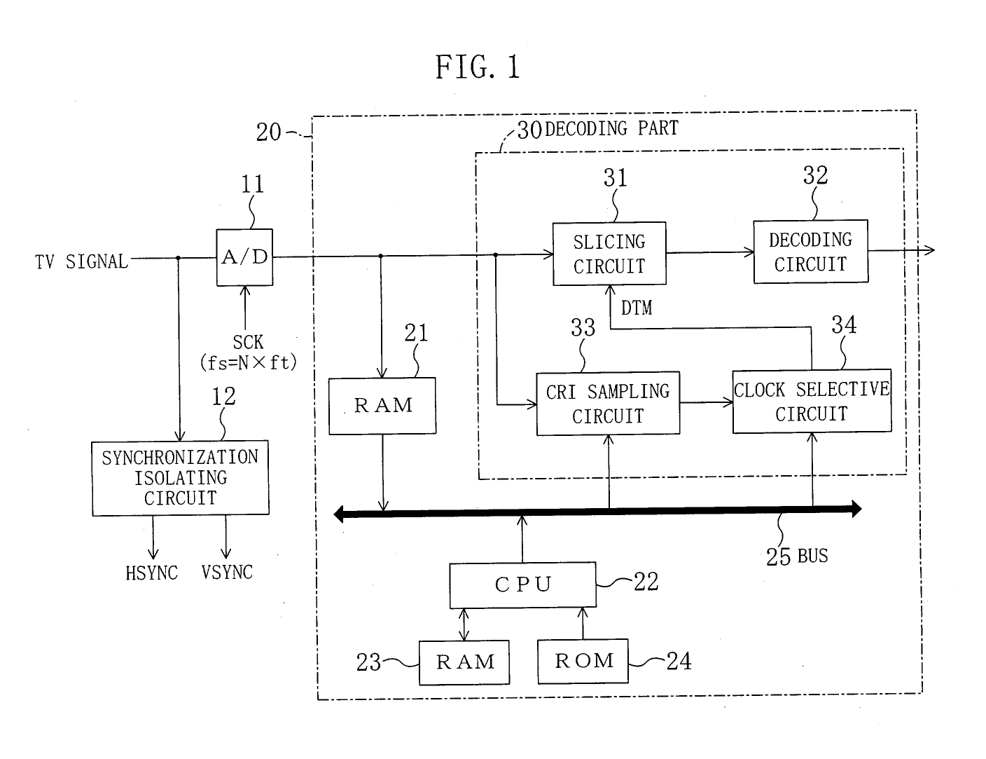

FIG. 1 is a view showing a structure of a teletext decoder as a decoder for a digital information signal according to a first embodiment of the present invention. Referring to FIG. 1, reference numeral 11 designates an A/D converter which A/D converts a TV signal during a blanking interval, reference numeral 12 designates a synchronization isolating circuit which isolates a horizontal synchronization signal HSYNC and a vertical synchronization signal VSYNC from the TV signal, and reference numeral 20 designates a processing part of a channel select microcomputer. The processing part 20 of the channel select microcomputer comprises a RAM 21 for storing a digital signal generated by the A/D converter 11, a CPU 22, a RAM 23, a RAM 24 and a decoding part 30. The decoding part 30 comprises a slicing circuit 31, a decoding circuit 32, CRI sampling circuit 33 and a clock selective circuit 34.

Here, since a teletext signal as the digital information signal is superposed on the TV signal and transmitted at a transmission clock frequency ft (=6.9375 MHz), sampling is performed at a clock SCK (frequency fs (=N×ft): N is a positive integer) which is synchronized with the transmission clock at a receiver side. Therefore, in the teletext signal, a CRI (clock Run-in) signal for 16 clocks is added as synchronization data for implementing clock synchronization at a head of the data. Then, an optimum phase of a sampling clock is determined from this CRI signal and data of 45 bites (including the CRI signal) during one horizontal interval are sampled in the determined clock phase.

More specifically, the teletext signal superposed during the blanking interval of the TV signals is sampled using the sampling clock SCK of a frequency fs which is higher than the transmission frequency ft and converted to digital data by the A/D converter 11. The digital data are stored in the RAM 23 through the RAM 21. Meanwhile, in the decoding part 30, the CRI sampling circuit 33 samples the CRI signal which is the synchronization data of the teletext signal from the digital data, and the clock selective circuit 34 selects data extracting timing such that an amplitude of the sampled CRI signal becomes maximum and applies it to the slicing circuit 31. The slicing circuit 31 samples data at data extracting timing DTM selected by the clock selective circuit 34, from the digital data output from the A/D converter 11 and digitize them in accordance with a slice value. The digitized data are decoded in accordance with a teletext standard by the decoding circuit 32.

Here, a transversal filter is not provided in the structure shown in FIG. 1. According to this embodiment of the present invention, the CPU 22 executes a program previously stored in the ROM 24 to control the clock selective circuit 34 and controls the data extracting timing DTM optimally. Thus, even if the TV signal superposed by the teletext signal are influenced by phase and frequency distortion on a transmission line, the information of the teletext signal can be appropriately reproduced.

A principle of optimum control of the data extracting timing according to this embodiment of the present invention will be described hereinafter.

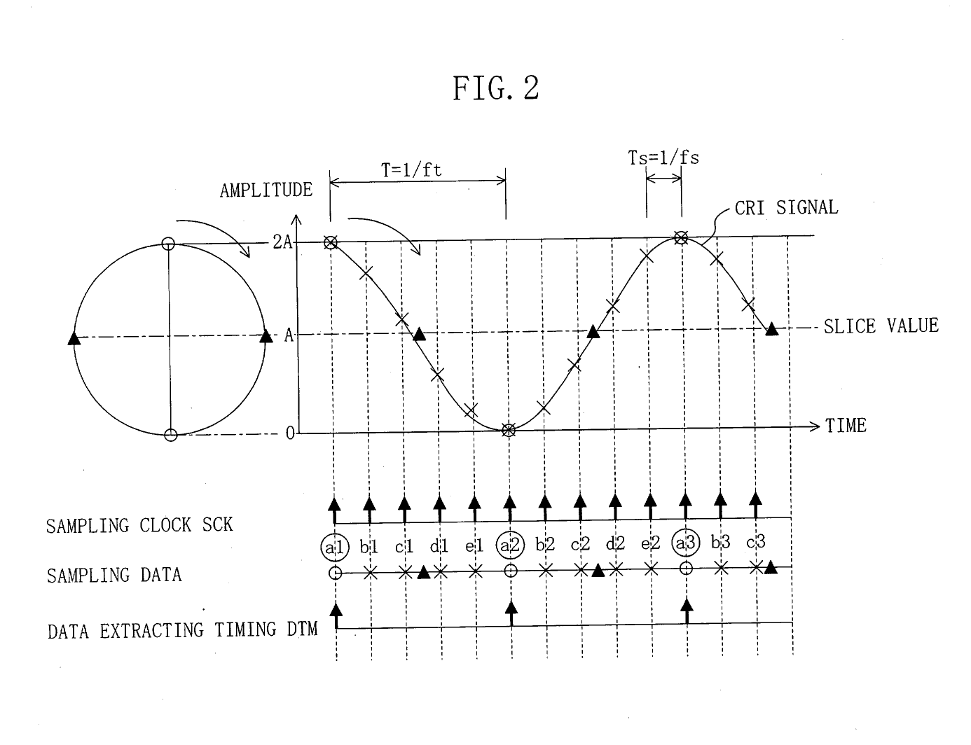

FIG. 2 is a conceptual diagram showing a relation between the CRI signal and the sampling under an ideal condition, that is, in case the phase and frequency distortion does not occur on the transmission line. According to FIG. 2, it is assumed that the frequency fs of the sampling clock SCK is five times higher than the transmission frequency ft of the teletext signal (that is, N=5). In FIG. 2, the circumference of a circle having a radius of A on the left side corresponds to one cycle (2/ft) of the CRI signal and a sinusoidal wave on the right side corresponds to the circle. More specifically, the CRI signal is schematically represented as the sinusoidal wave signal having an amplitude of 2A. Then, a mark ‘◯’ represents transmitted signal data, a mark ‘X ’ represents data sampled by the sampling clock SCK and a mark ‘▴’ represents timing when the CRI signal intersects with the slice value A for digitizing the teletext signal.

As can be seen from FIG. 2, under the ideal condition, the timing when the CRI signal intersects with the slice value A is between timings c1 and d1, between timings c2 and d2 and between timings c3 and d3. At this time, at the timings a1, a2 and a3, if one sample is selected every five sample, the transmitted teletext signal can be precisely reproduced.

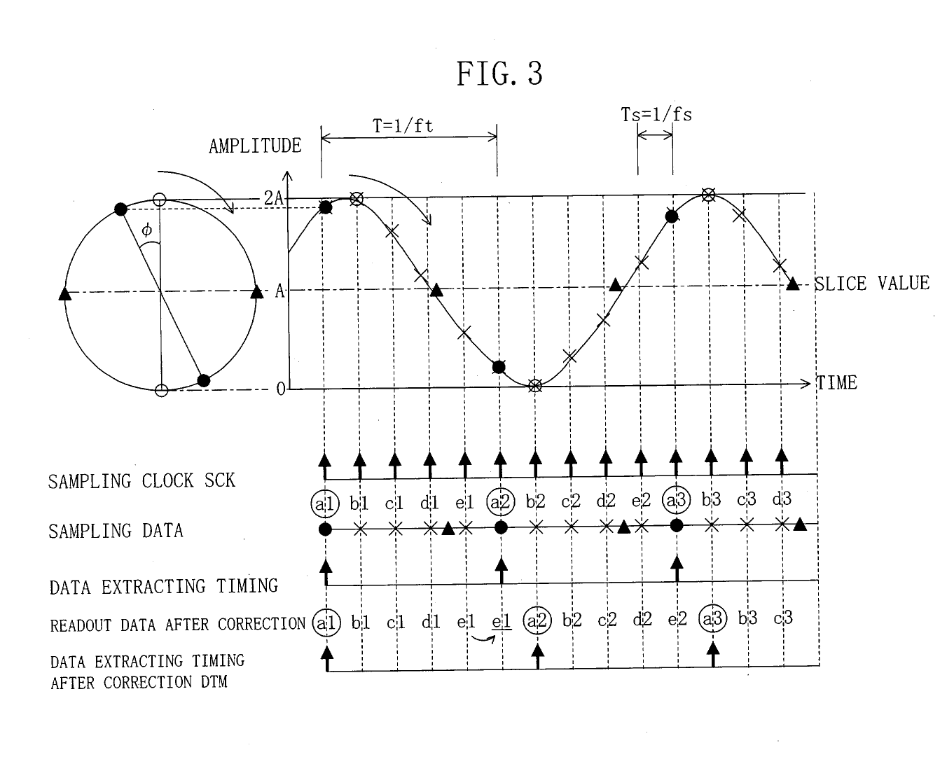

As compared with FIG. 2, FIG. 3 shows a condition in which the phase of the sampling clock is advanced by one clock from the ideal timing. Referring to FIG. 3, a mark ‘●’ represents sampling data in case it is sampled at timing shifted by one clock. In case of FIG. 3, the timing when the CRI signal intersects with the slice value A is between timings d1 and e1, between timings d2 and e2 and between timings d3 and e3, which are delayed by one clock as compared with the case under the ideal condition.

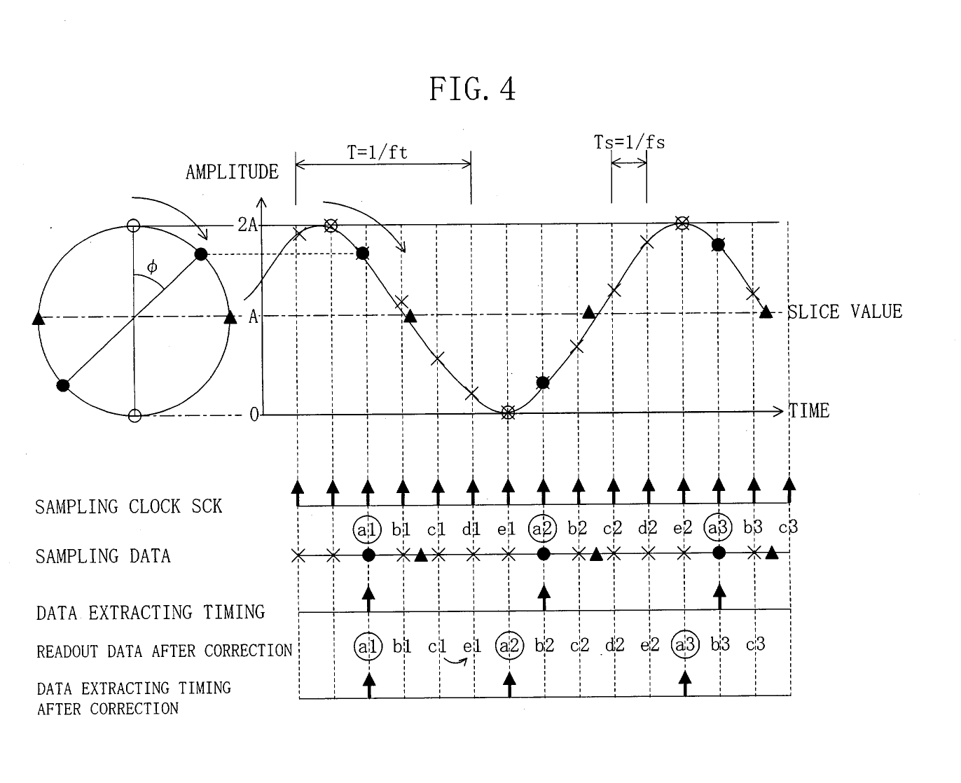

In addition, FIG. 4 shows a condition in which the phase of the sampling clock is delayed by one clock from the ideal timing. In case of FIG. 4, the timing when the CRI signal intersects with the slice value A is between timings bi and c1, between timings b2 and c2 and between timings b3 and c3, which are advanced by one clock as compared with the case under the ideal condition shown in FIG. 2.

Then, according to this embodiment of the present invention, a difference between each sampling data and the slice value A is found and reversing timing at which a sign of the difference reverses is the timing when the CRI signal intersects with the slice value A. As shown in FIG. 3, when the reversing timing at which the sign of the difference reverses is later than the original timing as shown in. FIG. 3, the data extracting timing is delayed. Meanwhile, as shown in FIG. 4, when the reversing timing at which the sign of the difference reverses is earlier than the original timing, the data extracting timing is hastened. Thus, even when the phase and frequency distortion occurs on the transmission line, the transmitted teletext signal can be precisely reproduced.

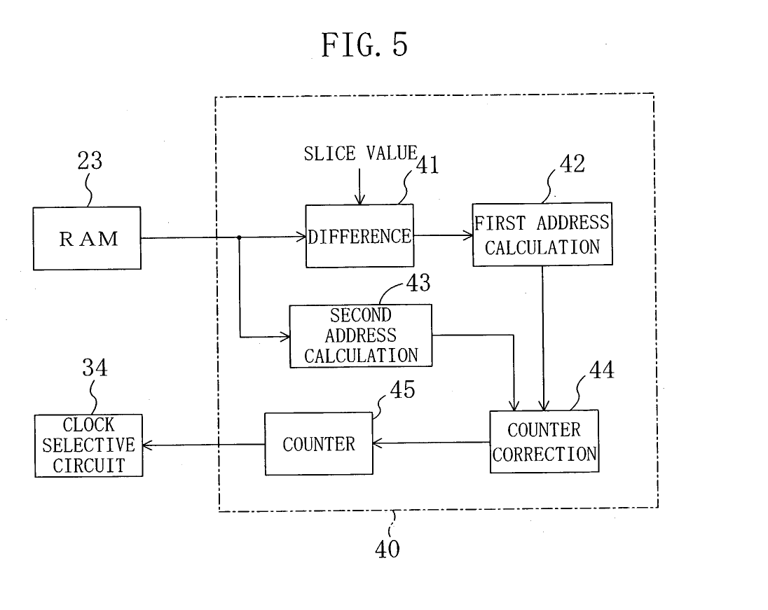

FIG. 5 is a block diagram conceptually showing a function of optimal control of the data extracting timing according to this embodiment of the present invention. A function 40 is implemented when the CPU 22 executes a program stored in the ROM 24. As shown in FIGS. 2 to 4, five sampling data are provided during one cycle T (=1/ft) of the teletext signal and since data are selected once every five samples, the control according to this embodiment can be easily implemented using a quinary counter 45. Timing setting means constituted by first and second address calculating means 42 and 43, a counter correcting means 44 and the counter 45.

Referring to FIG. 5, a difference means 41 evaluates a difference between the digital data read from the RAM 23 and the slice value which is a reference for digitizing and the first address calculating means 42 outputs address in which the sign of the difference evaluated by the difference means 41 reverses as a first address to the counter correcting means 44. Meanwhile, in case the sampling is performed under the ideal condition shown in FIG. 2, the second address calculating means 43 calculates address (timings d1, d2 and d3) just after the CRI signal intersects with the slice value A (‘▴’) as a second address, and outputs it to the counter correcting means 44 like the first address calculating means 42.

The counter correcting means 44 compares the first address with the second address and controls a counter value of the counter 45 which determines the data extracting timing. When the first address is bigger than the second address, that is, the reversing timing is delayed as shown in FIG. 3, the counter correcting means 44 controls the counter 45 such that the data extracting timing is delayed. On the other hand, when the first address is smaller than the second address, that is, the reversing timing is earlier as shown in FIG. 4, it controls the counter 45 such that the data extracting timing is hastened. The clock selective circuit 34 makes the slicing circuit 31 execute the data sampling operation in accordance with the data extracting timing determined by the counter 45.

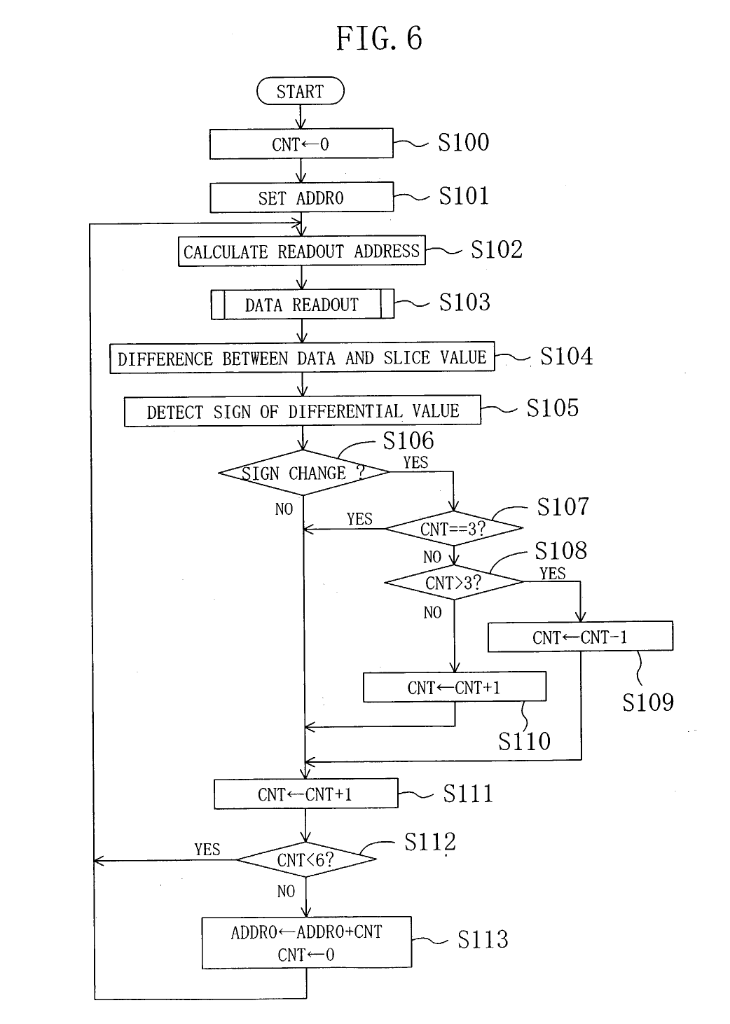

FIG. 6 is a flowchart of a program which executes the process according to this embodiment of the present invention. Referring to FIG. 6, at step S100, a count value CNT of the quinary counter 45 is cleared. Then, at step S101, a head address of a part corresponding to the CRI signal among the digital data taken in the RAM 23 working for the CPU 22 through the RAM 21 is set as an initial value ADDR 0 of a reading address ADDR.

Then, at step 102, address in which the counter value CNT is added to the initial value ADDR 0 is calculated as the reading ADDR. At step 103, data of the reading address ADDR is read from the RAM 23. At step 104, a difference between the read data and the slice value of the reference value for digitalizing is evaluated and then, at step 105, the sign of the difference value is detected.

Then, at step 106, it is determined whether the sign of the differential value is changed or not. If the sign is not changed, that is, if it is NO at step 106, it is determined that the CRI signal has not intersected with the slice value yet, at step 111, the counter 45 is incremented. When the counter value CNT does not exceed “6”, that is, when it is YES at step S112, the reading address ADDR is increased by one at step S102 and the same processes are repeated.

Meanwhile, when it is determined that the sign has been changed at step S106, the following process is performed. That is, when the counter value CNT is equal to “3” at that time, that is, it is YES at step 107, it is determined that the data are to be sampled formed on the ideal condition, the process proceeds to step S111 in which the counter 45 is incremented and the same processes are performed again. Meanwhile, when the counter value is not equal to “3”, that is, it is NO at step S107, it is determined that the data extracting timing is not correct at the present moment. When the counter value CNT is bigger than “3”, that is, it is YES at step S108, it is determined that the phase of the sampling clock is advanced as shown in FIG. 3, the counter 45 is decremented at step S109, whereby the data of the same address is read twice. Meanwhile, when the counter value CNT is less than “3”, that is, it is NO at step S108, it is determined that the phase of the sampling clock is delayed as shown in FIG. 4, the counter 45 is incremented at step S110, whereby the reading address is skipped by one.

Thus, the position in which the sign of the differential value is changed can be controlled so as to be the same as that under the ideal condition by correcting the count value CNT as described above, thereby enabling the optimum data selection. At step S112, when the count value CNT exceeds “6”, the initial value ADDR 0 of the reading address is updated and the counter 45 is cleared at step S113 and the process is continued.

According to this embodiment of the present invention, as described above, a difference between the part corresponding to the CRI signal among digital data obtained by the A/D converter 11 and the slice value is evaluated, the reversing timing at which the sign of the difference reverses is compared with the timing under the ideal condition, and the data extracting timing for reproducing the teletext signal is determined in accordance with the compared result. More specifically, when the timing at which the digital data of the part corresponding to the CRI signal intersects with the slice value is shifted because of the phase distortion on the transmission line, for example, since the shift can be detected as the shift of the reversing timing, the influence from the phase distortion on the transmission line can be optimally prevented by determining the data extracting timing DTM in accordance with the compared result with the timing under the ideal condition.

In addition, although this embodiment was described employing a case the frequency of the sampling clock is five times as high as the teletext transmission clock frequency as an example, the present invention is not limited to this and the value N may be other than five. In this case, the counter value “3” which is a reference for determination at steps S107 and S108 may be changed according to the value N.

Furthermore, even if the sampling clock is not synchronized with the teletext transmission clock, the present invention is applicable. In an example of an actual decoder, sampling frequency is set at 35.44 MHz while the transmission clock frequency is 6.9375 MHz in some cases. Even in this relation of the frequencies, it has been confirmed that the present invention is still effective. In other words, the degree of freedom of the sampling clock frequency can be improved by employing the present invention.

Embodiment 2

According to the first embodiment of the present invention, if the phase distortion is small, the optimum sampling timing can be obtained by controlling about one clock such that the reading address is skipped by one or the same address is read twice.

In fact, however, large phase distortion may occur in the teletext signal because of a ghost fault caused by reflection of television radio on a transmission line, or phase distortion caused by a detection and demodulation circuit of a television. In this case, the phase is largely shifted from the optimum sampling timing and it is possibly not corrected by the control according to the first embodiment of the present invention. If the correction is not fully performed, erroneous digitalized data are generated.

Then, according to the second embodiment of the present invention, a parity check is performed about the digitalized data, whereby it is determined that the data extracting timing is optimally controlled.

If the sampling timing is shifted because of the phase distortion and erroneous digitalized data are generated, the data are detected as a parity error. The larger the shift between the optimum sampling timing and the corrected sampling timing becomes, the more the parity increases in number. Then, experience shows that among 42 bytes which are provided by removing 2 bytes of the CRI signal and 1 byte of the framing signal from the data of 45 bytes which were superposed during one horizontal blanking interval, the error of 1 byte were indistinctive in terms of subjective assessment.

Therefore, according to this embodiment of the present invention, when the number of parity error exceeds “1”, it is determined that the reading address is not optimum and the amount of control of the reading address is updated so as to increase control of the correction. This kind of control is repeated such that the number of parity errors is within “1”. More specifically, the decoding circuit 32 performs the parity check about the teletext signal data which are digitalized by the slicing circuit 31 in FIG. 1. Then, when the result of the parity check is not correct, the digitalized data are replaced with a space code so as to prevent erroneous process in the decode circuit 32. Then, it is determined that the data extracting timing for digitalization is not correct, the detected result is fed back to the CPU 22. In the CPU 22, the counter correcting means 44 receives the feedback from the decoding circuit 32 and controls the amount of correction of the counter 45.

Thus, since the parity error is checked and the data extracting timing is corrected in accordance with the result, even when there is the phase distortion is so that the decode error is likely to occur, the decode error can be indistinctive in terms of subjective assessment.

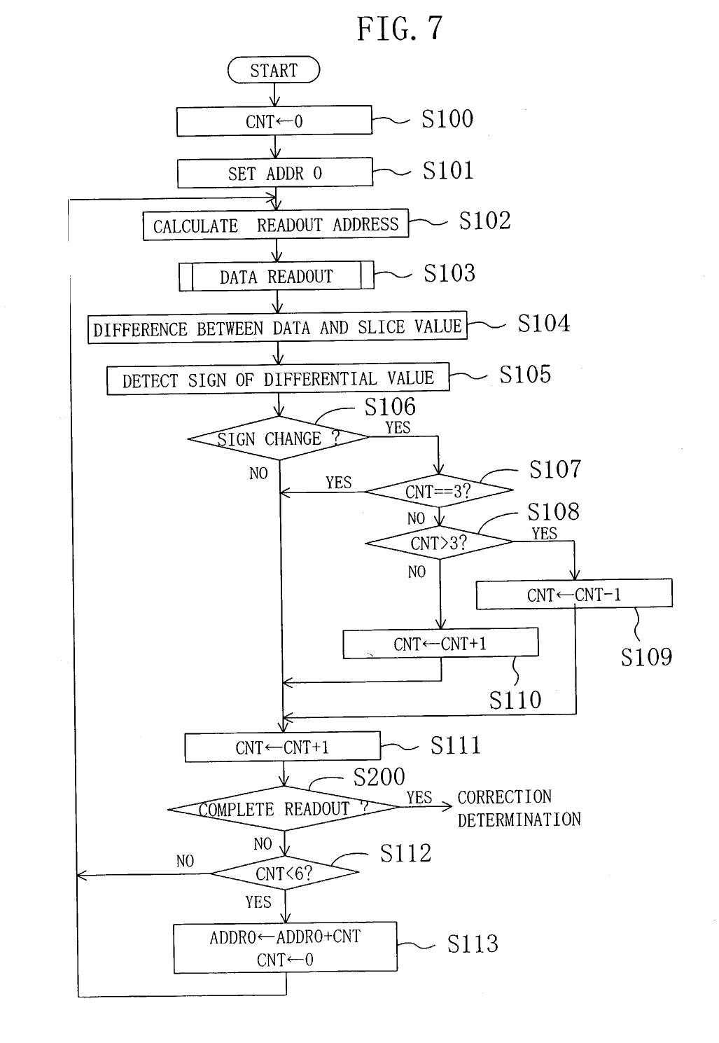

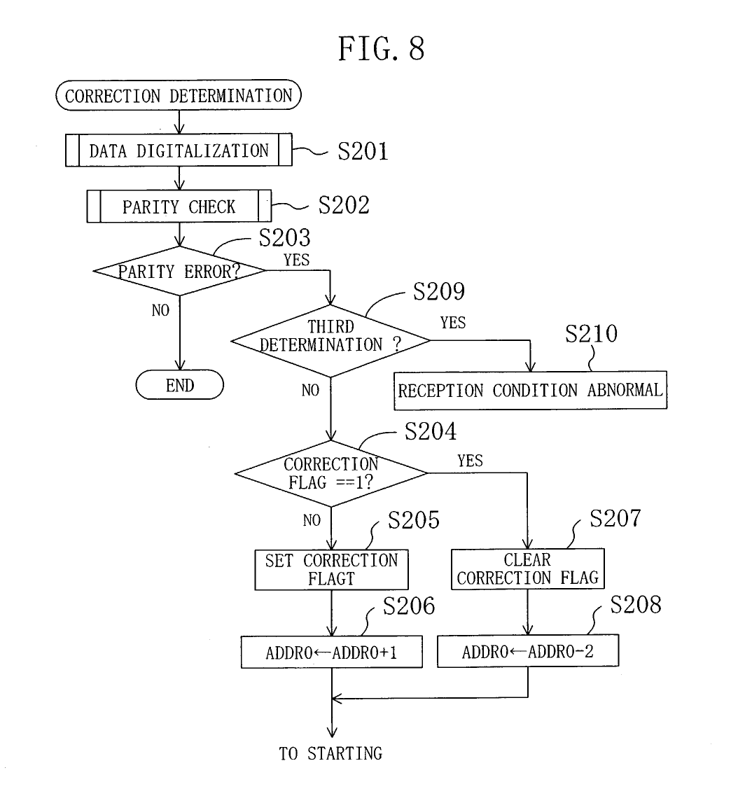

FIGS. 7 and 8 are flowcharts showing one example of concrete procedures of the process according to this embodiment of the present invention. Here, description of steps common to those in FIG. 6 is omitted.

At step 200, when the reading of the CRI signal is completed, it is determined whether the correction of the phase distortion is correctly performed or not, that is, a correction determining process is executed as follows. At step S201, the teletext signal data of 45 bytes are digitalized and at step S202, parity check is performed about the data of 45 bytes. Then, when the parity error is not generated, that is, it is NO at step S203, the correction determining process is completed and the decoding process is to be performed.

Meanwhile, when the parity error is detected, that is, it is YES at step S203, since the amount of the phase correction is not enough, the process moves to step S204. Then, when a correction flag is 0, that is, it is YES at step S204, the correction flag is set at step S205 and an initial value ADDR 0 of the head address is incremented to execute the process for phase correction from the beginning. Then, the correction is determined again and when the parity error is still detected, that is, it is YES at step S203, the correction flag is cleared at step S207 and the initial value ADDR 0 of the head address is decremented at this time and the phase correction process is repeated. When the parity error is still detected, that is, it is YES at step S209, it is determined that normal signal reception is not performed, the process is completed at step S210.

As described above, according to this embodiment of the present invention, since the parity check is performed about the result of the phase correction and feedback is applied to the phase correction process, stability of the reproducing operation can be improved. In addition, since an adaptive range of the phase correction is increased, it is possible to correspond to a wide signal receiving condition. Furthermore, since the condition is set so as to determine that the normal signal reception is not possible, failure as a system can be prevented.

(First Variation)

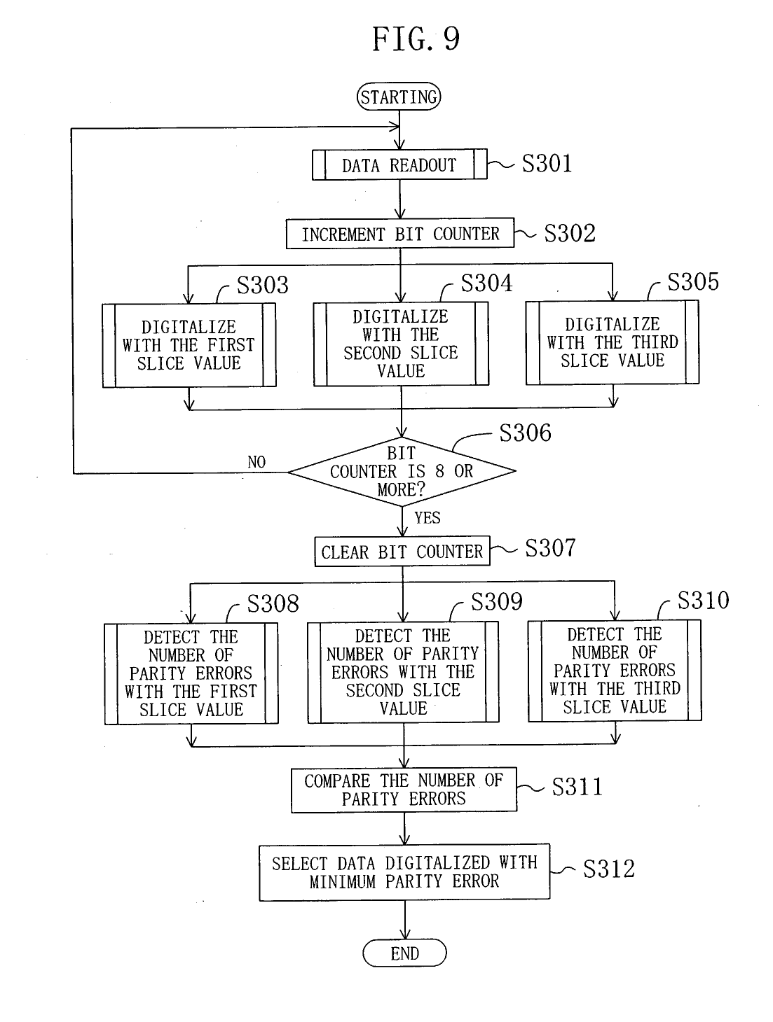

Furthermore, it is also applicable that the digital data are digitalized using a plurality of slice values which are different from each other, the parity check is performed about the respective digitalized data, and the digitalized data with which the parity error becomes minimum are selected as an object of the decoding process. FIG. 9 is a flowchart showing the process of the digitalization and the parity check in this case.

Here, as the plurality of slice values, there are three values such as an intermediate value calculated from a maximum value and a minimum value of an amplitude of the CRI signal, an upper limit value and a lower limit value which are calculated by adding or subtracting a constant value with the intermediate value centered. In addition, the upper and lower limit values are variable according to the amplitude of the received teletext signal data. The slice values are set by the CRI sampling circuit 33 shown in FIG. 1.

Referring to FIG. 9, at steps S301 to 305, the digitalization is performed with the first to third slice values every bit. When the digitalization of 1 byte is completed, that is, it is YES at step S306, at steps 307 to 310, the number of parity errors is checked about the respective first to third slice values. Then, at step S311, it is determined that the number of parity errors is big or small and step S312, 1 byte data with which the number of parity error is minimum is selected. This kind of process is repeated for the data of 45 byte during one horizontal blanking interval.

Thus, appropriate slice values can be set in accordance with the signal receiving condition and data reproducing in which there are less parity errors is possible.

Meanwhile, although the parity check is performed about three kinds of slice values in the above example, it is needless to say that even when a plurality of slice values other than three is set, the parity check can be similarly performed and the same effect can be obtained.

Embodiment 3

According to a third embodiment of the present invention, a parity check is performed in accordance with channel switching and ON of power supply of an apparatus which reproduces TV signals, so that an optimum slice value can be selected.

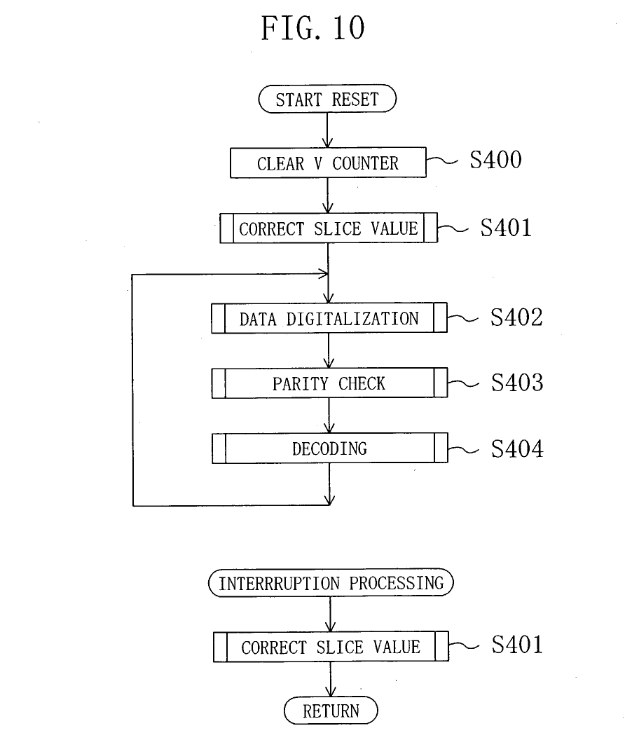

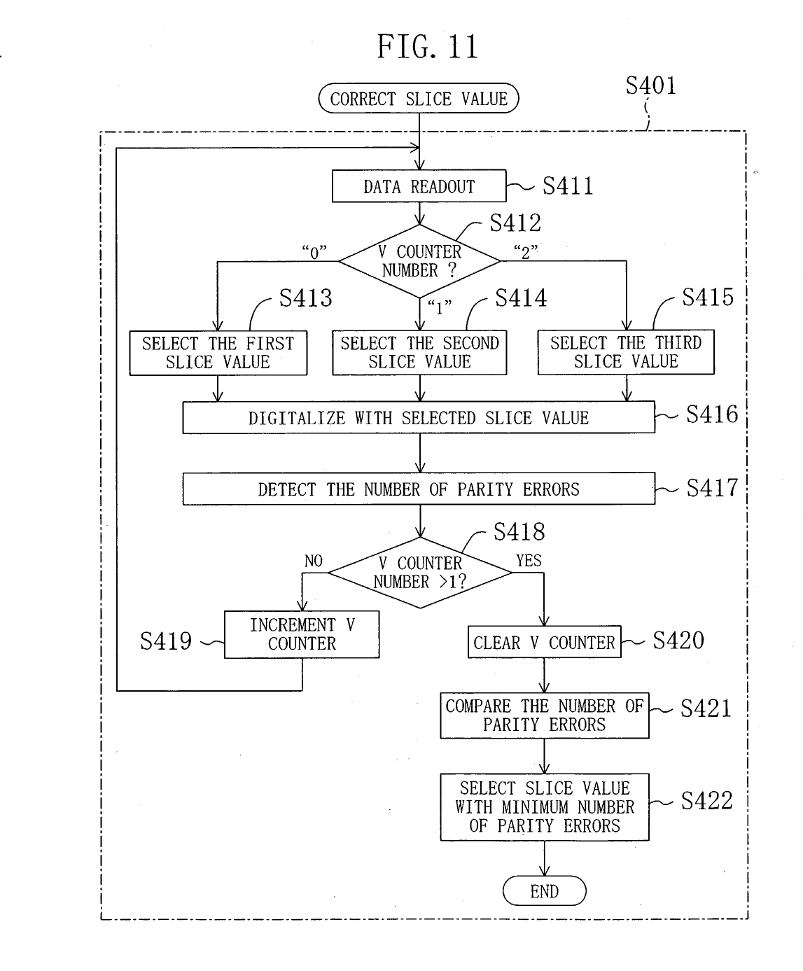

FIGS. 10 and 11 are flowcharts showing the process according to the third embodiment of the present invention. Referring to FIG. 10, at the time of reset starting according to ON of power supply of the apparatus which reproduces TV signals, for example, at step S400, a V counter for counting the number of times of TV signals every field is cleared. Then, at step S401, a slice value is corrected at the time of initialization after the reset starting. Then, at step S402, data are digitalized using an optimum slice value selected at step S400 and at step S403, a parity check is performed every byte about the data which were digitalized at step S402. Then, at step S404, the data obtained at step S403 are decoded. The processes S402 to S404 are repeated as a main process.

In addition, an interruption process is executed on receiving a channel switching signal from the apparatus for reproducing the TV signals such as a tuner. During the interruption process, the slice value is corrected at step S401.

Then, referring to FIG. 11, a concrete process of the correction of the slice value at step S401 will be described.

At steps S412 to S415, it is determined which one of the first to third slice values is selected about the digital data which were read at step S411 according to the counter value set in the V counter. Then, according to the selected slice value, the read data are digitalized at step S416 and the number of the parity error is detected with respect to the digitalized data of 1 byte at step S417.

Then, at step S418, it is determined whether the value of the V counter exceeds “1” or not and if not, the process moves to step S419 in which the V counter is incremented and the same processes are repeated. Meanwhile, if the value of the V counter exceeds “1”, the V counter is cleared at step S420 and the number of the parity errors found with respect to the respective first to third slice values are compared at step S421. Then, according to the result from the comparison, the slice value in which the number of parity errors is minimum is selected at step S422.

The slice value selected at step S422 is fixed until the next interruption process.

As described above, according to this embodiment of the present invention, even when a frequency characteristic of the digital signal is changed and distorted at the time of channel switching operation and power ON operation of the apparatus for reproducing TV signals, the data can be digitalized using the slice value according to the signal condition, whereby stable data reproducing process in which there are less parity errors can be executed.

Meanwhile, although the parity check is performed about three kinds of slice values in the above example, it is needless to say that even when a plurality of slice values other than three is set, the parity check can be similarly performed and the same effect can be obtained.

In addition, according to each of the embodiments of the present invention, although description was made of an example of a teletext signal as a digital information signal, the present invention can be applied to another signal which is superposed and transmitted during a blanking interval of TV signals such as a closed caption signal, for example. According to the closed caption signal, since only the transmission clock frequency and an amount of information superposed during one horizontal interval are different, the method for sampling the data is the same.

As described above, according to the present invention, when the timing of intersecting of the digital data of the part corresponding to the synchronization data with the slice value is shifted because of the phase distortion on the transmission line, for example, the shift of the timing is detected as a shift of timing when the sign of the difference reverses. Thus, if the data extracting timing is determined in accordance with the compared result with the predetermined timing, the phase distortion on the transmission line can be appropriately prevented. Therefore, it is possible to obtain the optimum data extracting timing by a simple way of software processing and data reproduction in which there are less errors can be implemented. Furthermore, the result of the parity check and the selection from the plurality of slice values are used together, it is possible to easily implement the data reproduction in which there are less errors in accordance with the signal receiving condition.

What is claimed is:

1. A method for reproducing a digital information signal superposed and transmitted during a blanking interval of TV signals, comprising:
a first step of sampling and A/D converting said TV signals during the blanking interval at a frequency higher than a transmission frequency of said digital information signal;
a second step of evaluating a difference between a slice value and a part corresponding to synchronization data of said digital information signal among the digital data obtained at said first step; and
a third step of comparing reversing timing when a sign of the difference obtained at said second step reverses with predetermined timing and determining data extracting timing for reproducing said digital information signal from said digital data according to the compared result.

2. A method according to claim 1, wherein the sampling frequency at said first step is a frequency corresponding to an integral multiple of the transmission frequency of said digital information signal.

3. A method according to claim 1, wherein the predetermined timing at said third step is timing corresponding to timing when a sign of a difference reverses on the assumption that no distortion occurs in a transmission system and ideal sampling is performed at said first step.

4. A method according to claim 1, wherein in said third step, when said compared result shows that the reversing timing is earlier than the predetermined timing, the data extracting timing is hastened, while the data extracting timing is delayed when said compared result shows that the reversing timing is later than the predetermined timing.

5. A method according to claim 1, further comprising a fourth step of extracting data from said digital data according to the data extracting timing determined at said third step and digitalizing the extracted data based on a slice value,
wherein said digitalized data are decoded into said digital information signal.

6. A method according to claim 5, further comprising a fifth step of performing a parity check about said digitalized data,
wherein when a parity error is detected at said fifth step, the data extracting timing determined at said third step is corrected.

7. A method according to claim 5, wherein said fourth step is performed using a plurality of slice values different from each other, a parity check is performed with respect to respective obtained digitalized data and the digitalized data with which the parity error is minimum is selected for decoding.

8. A method according to claim 5, wherein interruption process is performed in accordance with a channel switching operation and a power ON operation of an apparatus for reproducing said TV signals, and wherein in said interruption process, said fourth step is performed using a plurality of slice values different from each other, a parity check is performed with respect to respective obtained digitalized data and a slice value with which the parity error is minimum is selected for the following digitalizing process.

9. A decoder for reproducing a digital information signal superposed and transmitted during a blanking interval of TV signals, comprising:
an A/D converter for sampling and A/D converting said TV signals during a blanking interval at a frequency higher than the transmission frequency of said digital information signal;
difference means for evaluating a difference between a slice value and a part corresponding to synchronization data of said digital information signal among digital data generated by said A/D converter; and
timing setting means for comparing reversing timing when a sign of the difference obtained by said difference means reverses with predetermined timing and determining data extracting timing for reproducing said digital information signal from said digital data in accordance with the compared result.

10. A decoder according to claim 9, further comprising a decoding part which extracts data from said digital data in accordance with the data extracting timing determined by said timing setting means, digitalizes the extracted data based on a slice value and reproduces it as said digital information signal.
